(19) United States
(12) Patent Application Publication
(10) Pub. No.: US 2012/0230859 A1
(43) Pub. Date: Sep. 13, 2012

(54) MARAGING STEEL ARTICLE AND METHOD OF MANUFACTURE

(75) Inventors: Joseph F. MUHA, Pittsburgh, PA (US); Andrzej L. WOJCIESZYNSKI, Pittsburgh, PA (US); Brian J. MCTIERNAN, Sewickley, PA (US)

(73) Assignee: ATI POWDER METALS LLC

(21) Appl. No.: 13/403,368

(22) Filed: Feb. 23, 2012

Related U.S. Application Data
(63) Continuation of application No. 11/218,618, filed on Sep. 6, 2005.

(51) Int. Cl. B32B 15/00; B22F 3/15; C22C 38/44; B22F 3/26

(52) U.S. Cl. 419/27; 419/29; 148/335

(57) ABSTRACT

A fully dense, powder-metallurgy produced maraging steel alloy article of prealloyed powder for use as a tool for high temperature applications. The article in the as-produced condition having a hardness less than 40 HRC to provide machinability and thereafter the article upon maraging heat treatment having a hardness greater than 45 HRC. A method for producing this article comprises compacting prealloyed powder to produce a fully dense article having a hardness less than 40 HRC and thereafter maraging heat treating to a hardness greater than 45 HRC.

### BACKGROUND OF THE INVENTION

1. Field of the Invention

The invention relates to the manufacture of a maraging steel article with a specific composition using a powder metallurgy processing method. The steel as produced by practicing this invention, either in the AS-HIP condition or HIPed and hot worked condition, is appropriate for applications involving high temperatures or cyclic heating and cooling. The steel article of the invention has a hardness of less than 40 HRC after manufacturing and after solution heat treating, allowing the article to be machined. However, after the manufacture of the article and the subsequent maraging treatment, its hardness is greater than 45 HRC.

The applications for the steel article of the invention include processing of plastics or of liquid or hot solid metals, which include but are not limited to mold dies for the casting of liquid metals, mold dies for plastics, dies for forging other metals and dies for extruding. The cyclical heating and cooling of tools for these applications characterize these applications. This cyclical heating and cooling create sufficient stresses in the tool to cause thermal fatigue cracking, also known as heat checking. Different applications can tolerate different amounts of heat checking. For some products that require a high quality cosmetic appearance, the dies must be replaced after very limited heat checking has occurred. For other products that may not require this high quality cosmetic appearance, the dies can be used even with severe heat checking. In all cases, the majority of dies eventually fail and are replaced due to thermal fatigue cracking.

Existing hot work tool steels can suffice for the products with less stringent cosmetic requirements or shorter life time cycles. However, for product with a high cosmetic requirement, there is a need for a tool with a longer useful service life to satisfy the demands of the production practice.

2. Prior Art

Tools are used in several applications involving the processing of hot metal. This metal can be in the liquid form, as in die-casting, or in the solid form, as in hot extrusion and hot forging. The useful life of all these tool materials is typically limited by thermal fatigue cracking. That is, as the process proceeds, more thermal fatigue cracks initiate on the surface of the tool, and existing thermal fatigue cracks grow. The die is replaced when the extent of thermal fatigue cracking renders the produced part as being of unacceptable quality. Requirements of steel used for high temperature applications include:

The material must have the capability to be heat-treated to greater than 45 HRC, which is the typical minimum working hardness for most tools of the prior art to maintain shape.

The material must also exhibit good high temperature strength. Fatigue cracking is related to the strength of the material. Therefore, a higher strength is one factor that can improve the resistance to thermal fatigue cracking.

Due to the die being exposed to high temperatures, softening of the die material can occur. This softening of the material will also decrease the strength of the material, making it more susceptible to thermal fatigue cracking. Therefore a tool material must exhibit good resistance to softening, also known as temper resistance.

Many of the tools used in the above operations are taken out of service due to the presence of thermal fatigue cracks. Thermal fatigue cracking has similarities to conventional fatigue cracking. However, in the case of thermal fatigue cracking, the stresses are introduced in the tool by cyclic heating and cooling. Therefore, it is important that material for such a tool exhibit good resistance to thermal fatigue cracking.

The thermal expansion of the tool during the heating and cooling cycle introduces stresses into the tool. Therefore, the material should have as low a coefficient of thermal expansion as possible or at minimum lower than the current materials in use.

Many tools are coated for resistance to erosion. Therefore, the die material must be capable of being coated by PVD (physical vapor deposition) or other relevant coating.

Although some applications may use the invention in the AS-HIP (as hot isostatically pressed) condition, most applications will require the hot working of the material into smaller sections suitable for the customer. Therefore, the material must have good hot workability.

Several materials are currently used the for hot work applications. The H series tool steels were developed for these applications, with the most common being the 5Cr hot work tool steels. This includes the steels known in the United States as H13 and H11. The H13 steel class is nominally in weight percent 0.38 carbon, 5.25 chromium, 1.25 molybdenum, 1.0 silicon and 1.0 vanadium. The H11 steel class is essentially the same as the H13 class but with weight percent 0.5 vanadium. For more severe applications, the H11 or H13 steel is typically processed using electro slag remelting (ESR) or vacuum arc remelting (VAR) methods.

Several variations of these 5Cr tool steels have also been used. Among the most notable are H11 with lower silicon content for increased toughness. The other is a H11 with lower silicon and added molybdenum for improved temper resistance. Table 1 shows the nominal chemistries of some standard and some non-standard commercially available tool steels.

TABLE 1
Nominal Chemical Composition of Selected Standard
and Non Standard Hot Work Tool Steels

| Alloy | | | | | | | | |
|---|---|---|---|---|---|---|---|---|
| Designation | C | Si | Mn | Cr | Mo | V | Co | Fe |
| H10 | 0.32 | 0.25 | 0.30 | 3.00 | 2.80 | 0.50 | — | Bal. |
| H10A | 0.32 | 0.25 | 0.30 | 3.00 | 2.80 | 0.50 | 3.00 | Bal. |
| H11 | 0.40 | 1.00 | 0.25 | 5.30 | 1.60 | 0.40 | — | Bal. |
| H13 | 0.40 | 1.00 | 0.40 | 5.30 | 1.40 | 1.00 | — | Bal. |
| H19 | 0.45 | 0.40 | 0.40 | 4.50 | 3.00 | 2.00 | 4.50 | Bal. |
| Com. 1 | 0.36 | 0.20 | 0.50 | 5.25 | 1.65 | 0.50 | — | Bal. |
| Com. 2 | 0.36 | 0.20 | 0.50 | 5.00 | 2.35 | 0.60 | — | Bal. |
| Com. 3 | 0.36 | 0.20 | 0.40 | 5.20 | 1.95 | 0.60 | — | Bal. |
| 1.2367 | 0.38 | 0.40 | 0.40 | 5.00 | 3.00 | 0.60 | — | Bal. |
| Com. 4 | 0.38 | 0.20 | 0.25 | 5.00 | 3.00 | 0.60 | — | Bal. |

Among other materials which have been used in the past for hot work application are maraging steels. Most of them contain approximately 18% nickel and some titanium and obtain their hardness by precipitation of Ni—Mo and Ni—Ti particles. Many of these steels are aged using a relatively low temperature, typically less than 1000° F. which can limit the usefulness of the material when exposed to higher temperatures. Table 2 shows the nominal chemistries of some commercially available maraging steels.

TABLE 2
Nominal Chemical Composition of Selected Maraging Steels

| Alloy | C | Si | Mn | Ni | Cr | Mo | Co | Cu | Ti | Al | B |
|---|---|---|---|---|---|---|---|---|---|---|---|
| Com. 1 | 0.008 | 0.15 | 0.05 | 17.5 | 0.10 | 4.90 | 11.00 | 0.20 | 0.13 | — | 0.003 |
| Com. 2 | 0.02 | 0.04 | 0.03 | 18.5 | 0.05 | 4.80 | 7.50 | — | 0.40 | 0.10 | 0.003 |
| Com. 3 | 0.02 | 0.05 | 0.03 | 18.5 | 0.10 | 4.90 | 9.00 | — | 0.60 | 0.10 | 0.003 |
| Com. 4 | 0.02 | — | — | 12.0 | — | 8.00 | 8.00 | — | 0.50 | 0.05 | — |

Some conventional maraging steels have been developed in the past with good thermal fatigue resistance and strength, but when produced by conventional methods have exhibited poor hot workability during processing from ingot stage to finished form. This poor hot workability results in either a defective final product or an insufficient yield (less than 50%) from ingot stage to finished stage to render the product commercially viable.

### SUMMARY OF THE INVENTION

The invention provides a new powder metallurgy produced maraging steel alloy article to be used as a tool for high temperature applications that satisfies the above-stated requirements. The article is fully dense and of prealloyed powder particles.

TABLE 3
Chemistry Ranges for Alloy of Invention

| | C | Mn | Si | Cr | Mo | Ni | Co | S |
|---|---|---|---|---|---|---|---|---|
| Broad | 0.00-0.08 | 0.00-1.00 | 0.00-1.00 | 2.50-6.00 | 6.00-10.00 | 1.00-4.00 | 9.00-14.00 | 0.00-0.30 |
| Range | | | | | | | | |
| Preferred | 0.00-0.05 | 0.10-0.050 | 0.010-0.50 | 4.00-5.75 | 7.00-9.00 | 1.50-3.00 | 10.00-13.00 | 0.005-0.05 |
| Range | | | | | | | | |
| More | 0.01-0.04 | 0.20-0.40 | 0.15-0.40 | 4.70-5.30 | 7.50-8.50 | 1.70-2.30 | 10.75-12.00 | 0.01-0.03 |
| Preferred | | | | | | | | |
| Range | | | | | | | | |

Hardening of the material is achieved by solution annealing and ageing, i.e. heating at a prescribed temperature for a prescribed length of time. This allows small precipitate particles to form, which in turn-harden the low carbon martensitic structure of the material.

In the following, the importance of the individual alloying elements and their mutual interaction will be explained. All percentages related to the chemical composition in the specification and claims are in weight percent.

Molybdenum is a key element in the strengthening of this maraging steel, as the precipitate responsible for hardening the alloy is Fe₂Mo. It is also a key element in increasing the temper resistance of the alloy. Excessive quantities of molybdenum can allow the formation of detrimental delta ferrite.

Cobalt is required in a proper balance to prevent undesirable phases and to influence the aging process. Cobalt is an austenite former while preventing the formation of delta ferrite at high temperatures and has a minimal effect on the austenite to martensite transformation temperature. Cobalt also lowers the solubility of molybdenum in the martensitic matrix, thus making molybdenum more available for precipitation.

Chromium is desirable in some quantity for resistance to high temperature oxidation. Chromium in excessive quantity can result in the formation of delta ferrite.

Nickel also provides some benefit to oxidation resistance and is beneficial to mechanical properties. Excess nickel can cause the formation of austenite at typical service temperatures.

Carbon is not a critical element in the strengthening mechanism of this material.

Silicon is not a critical element in the properties of the alloy. Silicon may be used for deoxidizing during melting. It is a strong ferrite stabilizer.

Manganese is not critical for the properties of this alloy. It can be used to form manganese sulfide and therefore the content should be increased with increasing quantities of sulfur for enhanced machinability.

Sulfur may be present to promote machinability.

Vanadium, niobium, titanium, tungsten, zirconium, aluminum and other strong carbide and/or nitride formers are elements that are not desired and therefore should not exist in amounts above incidental impurity levels.

The alloy article of the invention is provided in the solution-annealed condition, which is performed by heating the material between 1740° F. and 1925° F. Hardening by maraging is achieved by heating the material between 1050° F. and 1360° F.

### BRIEF DESCRIPTION OF THE DRAWINGS

FIG. 1 is a graph showing the comparison of an alloy specimen within the composition limits of the invention produced by powder metallurgy and one produced by ESR with respect to ductility;

FIG. 2 is a graph comparing the thermal fatigue resistance of a specimen in accordance with the invention and a specimen of H13 alloy; and

FIG. 3 is a graph comparing hardness of a specimen in accordance with the invention and a specimen of H13 alloy.

### PERFORMED EXPERIMENTS AND SPECIFIC EXAMPLES

Experiments were performed to determine various properties that were considered important to the successful performance of the alloy article of the invention. This included rapid strain tensile testing as a measure of hot workability, thermal fatigue cracking, temper resistance, tensile testing at room temperature and at 1000° F., determination of coefficient of thermal expansion and coating trials.

The following is the steel composition of the invention and H13 composition of the test specimens:

| Element | Maraging Alloy | ESR H13 |
|---|---|---|
| C | 0.019 | 0.40 |
| S | 0.011 | 0.002 |
| Mn | 0.32 | 0.27 |
| Si | 0.27 | 1.05 |
| Cr | 4.92 | 5.46 |
| Mo | 7.87 | 1.22 |
| V | <0.005 | 0.91 |
| Co | 11.17 | 0.04 |
| Ni | 1.89 | 0.15 |
| P | 0.015 | 0.009 |
| Al | <0.005 | 0.01 |
| Nb | <0.005 | <0.01 |
| Ti | <0.005 | <0.01 |
| W | 0.007 | <0.01 |
| O | 0.011 | 0.0017 |
| N | 0.023 | 0.005 |

### Rapid Strain Tensile Test

The rapid strain tensile testing was performed using the alloy article of the invention produced by powder metallurgy and electro slag remelted material of the same composition. In rapid strain testing, the specimens were heated by direct resistance heating. After achieving and equalizing at the desired test temperature, a load was applied to achieve a strain rate of 550 in/in/minute. This test is useful in simulating the conditions that exist during the hot working of the material.

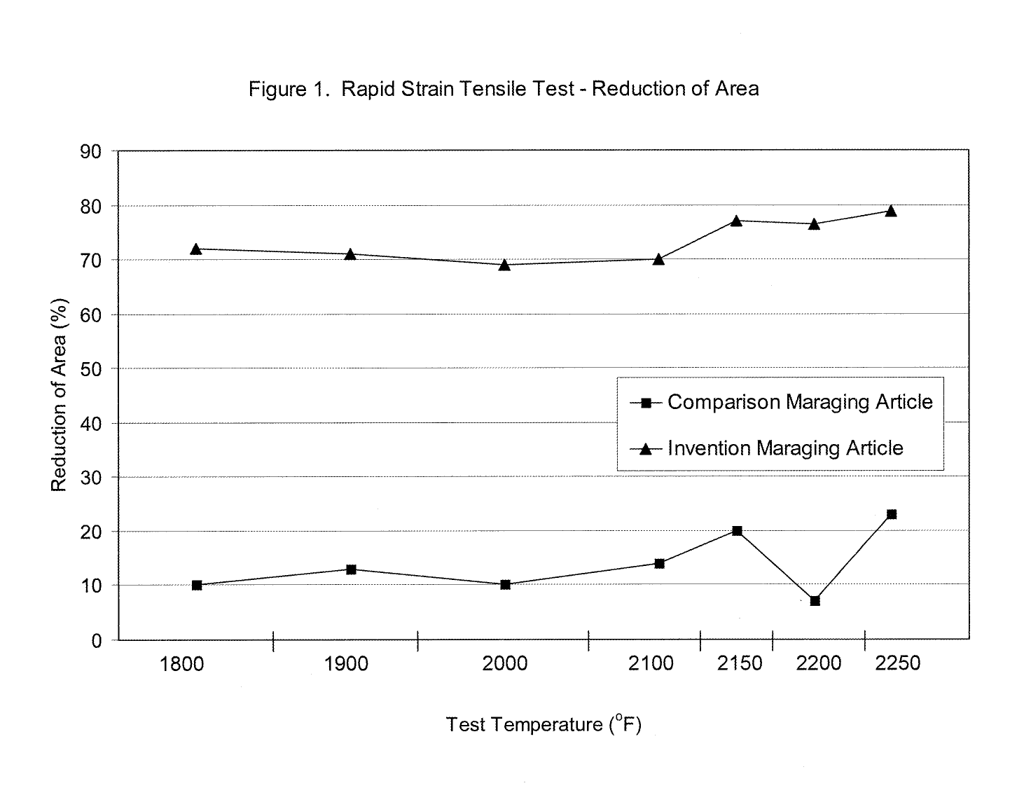

Test temperatures were 1800° F., 1900° F., 2000° F., 2100° F., 2150° F., 2200° F. and 2250° F. FIG. 1 shows the reduction in area of the rapid strain rate tensile test for the specimens produced of the alloy of invention and the ESR material of the same composition. This clearly shows a substantial ductility advantage for the powder metallurgy material. The ductility of the ESR material was insufficient to permit hot working.

The rapid strain tests also are in agreement with experience on full size trials. Two full size compacts of the powder metallurgy alloy composition of the invention were produced and consolidated by hot isostatic pressing. Each compact was then processed to an intermediate size and then to a final size by hot rolling. Neither compact exhibited any hot working difficulties and the process yield was within the range of standard processing yield for other tool steels. By contrast, trials with full size ingots produced by ESR or other conventional methods exhibited poor hot workability during processing at the commercial steel making facility, resulting in process yields well below standard, including two heats that were scrapped entirely.

### Thermal Fatigue Resistance

Another important characteristic of hot work tool steels is thermal fatigue resistance. There are several tests available to measure thermal fatigue cracking, although none of these tests are a standard method (e.g. ASTM). Some testing is performed by heating a specimen to a high temperature using an induction coil for heating, then allowing the specimen to cool. This is performed over a number of cycles, with the specimen being evaluated periodically during the test. Another method involves testing a specimen with an internal cooling cavity for cooling water. This specimen is repeatedly immersed into a liquid aluminum bath. Again the cracking is rated periodically during the test.

The testing for the alloy of the invention was performed using a ½″ square by 6″ long solid specimen produced by hot isostatic pressing and hot working. The test specimen can be tested simultaneously with up to five other specimens during the same procedure. The other specimen for this experiment was an ESR H13 material, which is the alloy most frequently used in aluminum die casting dies. The specimens were bolted to a holding plate affixed to the end of a mechanical arm which moved the specimens through the various stages of the test cycle. The arm immersed the specimens into molten aluminum to a depth of approximately 5 inches for 7 seconds. The specimens were then lifted out of the molten aluminum, moved to a position above a tank of water and then immersed into the water for 12 seconds. The specimens were then lifted out of the water, and the arm moved to a position above the molten aluminum for 5 seconds to dry the specimens. The cycle was then repeated.

During the trials, the specimens were periodically evaluated for thermal fatigue cracking, typically every 5,000 cycles. Two opposite faces of the specimens were cleaned using silicon carbide paper on a granite surface plate. The four cleaned corners of each specimen were then examined under a stereo microscope at a magnification of 90×. To avoid end effects, the examinations were conducted in an area 1⅜″ long, and which was located about 1⅜″ from the bottom end of the specimens.

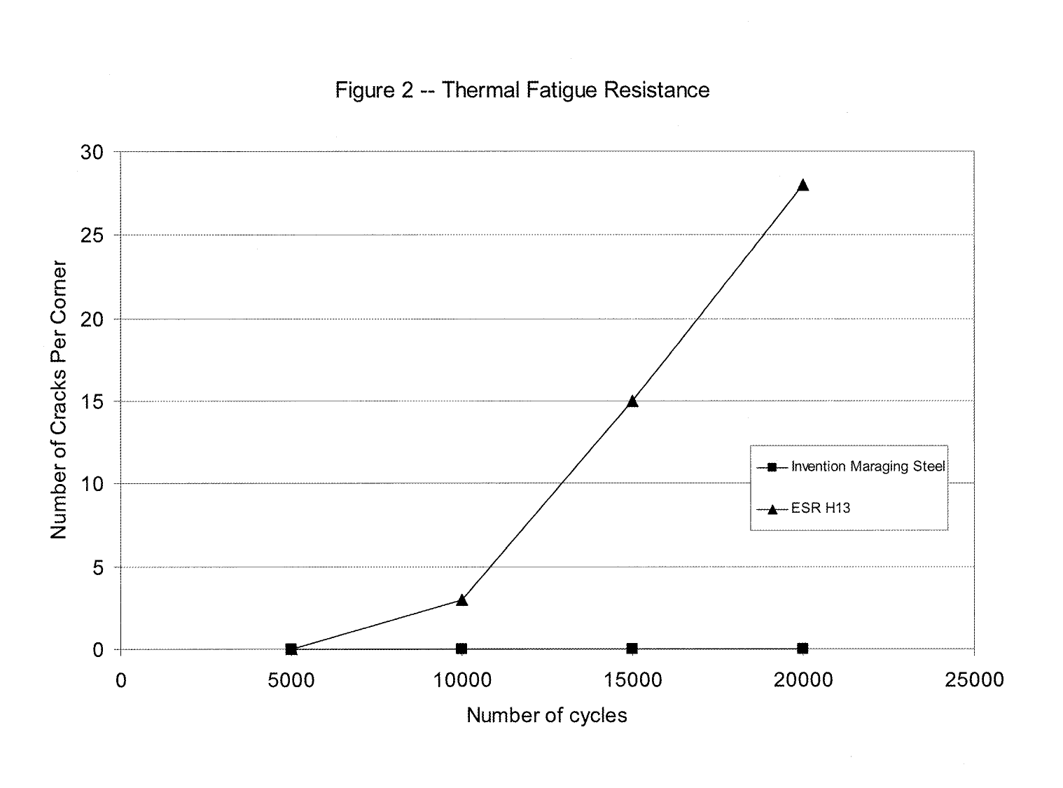

Each of the four corners was traversed along the 1⅜″ length and the number of cracks and their lengths were recorded. There are numerous ways this data can be normalized, but experience with the test has shown little deviation in the ranking of the specimens. Therefore, the simple total number of cracks was divided by the number of corners (4) to obtain the number of cracks per corner. FIG. 2 is a graphic representation of trial results of the powder metallurgy produced invention specimen versus the ESR H13 steel specimen. As previously discussed, thermal fatigue cracking is the most frequent cause of tool failure. For this reason, it is believed that thermal fatigue testing provides the most important indication of the improved performance of the alloy of invention.

### Temper Resistance

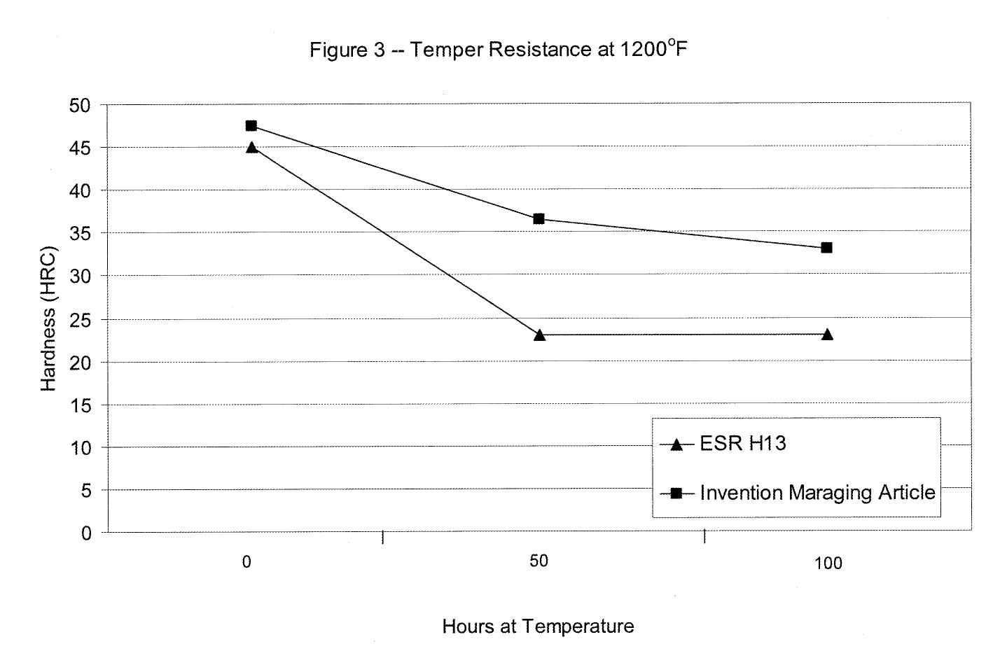

A trial to determine the temper resistance of the alloy article of the invention was also performed. Both the PM alloy specimen of the invention and the H13 steel specimen were heat-treated to similar hardness levels, using typical heat-treat cycles for each material. An initial hardness was measured and recorded. Then the specimens were placed into a furnace at a temperature of 1200° F. One set of specimens was removed after 50 hours at temperature and the hardness level tested and recorded. Another set of specimens was removed after 100 hours at temperature and the hardness level tested and recorded. FIG. 3 is a graphical representation of the hardness level as a function of hold time at 1200° F. It can be seen that the alloy of the invention has a superior temper resistance to H13 steel.

### Tensile Properties

Table 4 shows the results of tensile testing of the PM alloy article of the invention versus results for ESR H13 steel. Specimens tested were machined to a 0.250″ diameter with a 1.00″ gage length (4D). The results indicate that the alloy of invention has a higher yield and tensile strength at both room temperature and at 1000° F. This higher strength makes the alloy article of the invention less susceptible to thermal fatigue cracking.

TABLE 4
Tensile Properties

| | |
|---|---|
| Invention Maraging Article | ESR H13 Steel |
| (47 HRC) | (45 HRC) |

72° F.

| | | |
|---|---|---|
| UTS | 261 | 206 |
| YS | 207 | 185 |
| % EI | 10 | 12 |
| RA | 25 | 55 |

1000° F.

| | | |
|---|---|---|
| UTS | 161 | 145 |
| YS | 138 | 116 |
| % EI | 23 | 15 |
| RA | 62 | 75 |

### Coefficient of Thermal Expansion

Thermal expansion is an important factor, both in the resistance of a tool to thermal fatigue cracking and in the final product quality of a tool. In both cases, a smaller coefficient of thermal expansion is desired. The significance of the lower coefficient of thermal expansion is that with less dimensional change, the tool will be subjected to lower thermal stresses than a material with a greater dimensional change. The lower stresses present will thus render the tool more resistant to thermal fatigue cracking. The coefficient of thermal expansion was determined by the thermal dilatometric analysis (TDA) method. The coefficient of thermal expansion for the PM alloy article of the invention was determined to be 6.6×10⁻⁶ in./in./° F. over the temperature range of 72° F. to 1110° F. The ESR H13 die steel had a coefficient of 7.3×10⁻⁶ in./in./° F. over the temperature range of 72° F. to 1110° F.

### Field Coating Trials

Field trials have shown the PM invention alloy article is easily coated with either a physical vapor deposition (PVD) process or chemical vapor deposition (CVD) which employs a higher temperature than the PVD process. The alloy article of the invention was coated with TiN, TiAlN and CrN PVD coatings. The coatings were deposited at a high deposition rate at a temperature range of 750-850° F. for both the article of the invention and ESR H13 steel. Unlike many other maraging steels, this temperature is well below the aging temperature for the alloy article of the invention.

Similarly, the coating was deposited using a chemical vapor deposition process on both the alloy article of the invention and conventional tool steel material. Conventional tool steels are not well suited for CVD, as the coating process typically takes place at a temperature above the critical temperature of these alloys. The advantage provided by the article of the invention is that the CVD process results in the required heat treatment, namely solution annealing. After coating, the invention article requires only a single aging treatment. The nature of the maraging process is such that the dimensional changes of the tool are very minimal, allowing for good adherence of the coating to the substrate.

1-10. (canceled)

11. A method for producing a maraging steel article, the method comprising:
hot isostatic pressing a prealloyed steel powder to produce a fully dense article, the steel consisting of, in weight percent:
0.01 to 0.08 carbon;
0.10 to 1.00 manganese;
0.01 to 1.00 silicon;
2.50 to 6.00 chromium;
6.00 to 10.00 molybdenum;
1.00 to 4.00 nickel;
9.00 to 14.00 cobalt;
0.005 to less than 0.05 sulfur;
balance iron and incidental elements and impurities;
solution-annealing the fully dense article, wherein the solution annealing comprises heating the article at a temperature in the range of 1740° F. and 1925° F.;
maraging the solution-annealed article, wherein the maraging comprises heating the article at a temperature in the range of 1050° F. and 1360° F., wherein the fully dense steel has a hardness of less than 40 HRC before the maraging and a hardness of greater than 45 HRC after the maraging; and
applying at least one of a chemical vapor deposition coating and a physical vapor deposition coating to the fully dense article.

12. The method of claim 11, wherein the steel consists of, in weight percent:
0.01 to 0.05 carbon;
0.10 to 0.50 manganese;
0.01 to 0.50 silicon;
4.00 to 5.75 chromium;
7.00 to 9.00 molybdenum;
1.50 to 3.00 nickel;
10.00 to 13.00 cobalt;
0.01 to 0.03 sulfur;
balance iron and incidental elements and impurities.

13. The method of claim 11, wherein the steel consists of, in weight percent:
0.01 to 0.04 carbon;
0.20 to 0.40 manganese;
0.15 to 0.40 silicon;
0.70 to 5.30 chromium;
7.50 to 8.50 molybdenum;
1.70 to 2.30 nickel;
10.75 to 12.00 cobalt;
0.01 to 0.03 sulfur;
balance iron and incidental elements and impurities.

14. The method of claim 11, wherein the coating applied to the fully dense article comprises at least one layer comprising a nitride.

15. The method of claim 11, wherein the coating applied to the fully dense article comprises at least one of TiN, TiAlN, and CrN.

16. The method of claim 11, wherein a physical vapor deposition coating is applied to the fully dense article at a temperature in the range of 750 to 850° F.

17. The method of claim 11, wherein a chemical vapor deposition coating is applied to the fully dense article, wherein the solution-annealing of the fully dense article and the application of the chemical vapor deposition coating are performed simultaneously, and wherein the maraging is performed after the simultaneous solution-annealing and chemical vapor deposition.

18. A method for producing a maraging steel article, the method comprising:
hot isostatic pressing a prealloyed steel powder to produce a fully dense article, the steel consisting of, in weight percent:
0.01 to 0.08 carbon;
0.10 to1.00 manganese;
0.01 to1.00 silicon;
2.50 to 6.00 chromium;
6.00 to 10.00 molybdenum;
1.00 to 4.00 nickel;
9.00 to 14.00 cobalt;
0.005 to less than 0.05 sulfur;
balance iron and incidental elements and impurities;
solution-annealing the fully dense article by heating the article at a temperature between 1740° F. and 1925° F.; and
maraging the solution-annealed article by heating the article at a temperature between 1050° F. and 1360° F., wherein the fully dense steel has a hardness of less than 40 HRC before the maraging and a hardness of greater than 45 HRC after the maraging.

19. The method of claim 18, wherein the steel consists of, in weight percent:
0.01 to 0.05 carbon;
0.10 to 0.50 manganese;
0.01 to 0.50 silicon;
4.00 to 5.75 chromium;
7.00 to 9.00 molybdenum;
1.50 to 3.00 nickel;
10.00 to 13.00 cobalt;
0.01 to 0.03 sulfur;
balance iron and incidental elements and impurities.

20. The method of claim 18, wherein the steel consists of, in weight percent:
0.01 to 0.04 carbon;
0.20 to 0.40 manganese;
0.15 to 0.40 silicon;
4.70 to 5.30 chromium;
7.50 to 8.50 molybdenum;
1.70 to 2.30 nickel;
10.75 to 12.00 cobalt;
0.01 to 0.03 sulfur;
balance iron and incidental elements and impurities.

21. A method for producing a maraging steel article, the method comprising:
hot isostatic pressing a prealloyed steel powder to produce a fully dense article, the steel comprising, in weight percent:
0.01 to 0.08 carbon;
0.10 to 1.00 manganese;
0.01 to 1.00 silicon;
2.50 to 6.00 chromium;
6.00 to 0.00 molybdenum;
1.00 to 4.00 nickel;
9.00 to 14.00 cobalt;
0.005 to less than 0.05 sulfur;
balance iron and incidental elements and impurities;
solution-annealing the fully dense article, wherein the solution-annealing comprises heating the article at a temperature in the range of 1740° F. and 1925° F.; and
maraging the solution-annealed article, wherein the maraging comprises heating the article at a temperature between 1050° F. and 1360° F., wherein the fully dense steel has a hardness of less than 40 HRC before the maraging and a hardness of greater than 45 HRC after the maraging.

22. The method of claim 21, further comprising applying at least one of a chemical vapor deposition coating and a physical vapor deposition coating to the fully dense article.

23. The method of claim 22, wherein the coating applied to the fully dense article comprises at least one layer comprising a nitride.

24. The method of claim 22, wherein the coating applied to the fully dense article comprises at least one of TiN, TiAlN, and CrN.

25. The method of claim 22, wherein a physical vapor deposition coating is applied to the fully dense article at a temperature in the range of 750 to 850° F.

26. The method of claim 22, wherein a chemical vapor deposition coating is applied to the fully dense article, wherein the solution-annealing of the fully dense article and the application of the chemical vapor deposition coating are performed simultaneously, and wherein the maraging is performed after the simultaneous solution-annealing and chemical vapor deposition.

27. The method of claim 21, wherein the steel comprises, in weight percent:
0.01 to 0.05 carbon;
0.10 to 0.50 manganese;
0.01 to 0.50 silicon;
4.00 to 5.75 chromium;
7.00 to 9.00 molybdenum;
1.50 to 3.00 nickel;
10.00 to 13.00 cobalt;
0.01 to 0.03 sulfur;
balance iron and incidental elements and impurities.

28. The method of claim 21, wherein the steel comprises, in weight percent:
0.01 to 0.04 carbon;
0.20 to 0.40 manganese;
0.15 to 0.40 silicon;
4.70 to 5.30 chromium;
7.50 to 8.50 molybdenum;
1.70 to 2.30 nickel;
10.75 to 12.00 cobalt;
0.01 to 0.03 sulfur;
balance iron and incidental elements and impurities.

29. An article produced by the method of claim 21, wherein the article exhibits a hot ductility of at least 65% over a temperature ranging from 1800° F. to 2250° F.

30. An article produced by the method of claim 21, wherein the article exhibits a coefficient of thermal expansion less than 7.0×10⁻⁶ in/in/° F., over a temperature ranging from 72° F. to 1110° F.

31. An article produced by the method of claim 21, wherein the article exhibits a thermal fatigue resistance of one crack or less after 20,000 cycles.

32. An article produced by the method of claim 21, wherein the article maintains a hardness higher than 30 HRC after exposure to 1200° F. for 100 hours.
